(19) United States
(12) Patent Application Publication
(10) Pub. No.: US 2002/0018551 A1
(43) Pub. Date: Feb. 14, 2002

(54) Initiation of services in telecommunications network

(76) Inventor: Juha-Matti Sainio, Helsinki (FI)

Correspondence Address: Michael B. Lasky, Altera Law Group, Suite 100, 6500 City West Parkway, Minneapolis, MN, 55344-7701, US

(21) Appl. No.: 09/871,862

(22) Filed: Jun. 1, 2001

Related U.S. Application Data
(63) Continuation of application No. PCT/FI99/01040, filed on Dec. 15, 1999.

(30) Foreign Application Priority Data
Dec. 16, 1998 (FI) 982724

(51) Int. Cl. H04M 7/00

(52) U.S. Cl. 379/219

(57) ABSTRACT

The invention relates to a method of initiating services in a telecommunications network and a telecommunications network. The invention is based on the idea that at least two control point addresses are set to which a service request can be sent, and that the service request is sent to the address selected on the basis of the congestion information and/or the service request is sent to the set addresses one at a time, until service is initiated at one address.

### FIELD OF THE INVENTION

The invention relates to the initiation of services in a telecommunications network, especially in an intelligent network.

### BACKGROUND OF THE INVENTION

The rapid development of the telecommunication field has made it possible for operators to provide users with services of many different types. One such network architecture providing advanced services is called the Intelligent Network, for which the abbreviation IN is generally used. Examples of such services are the Virtual Private Network VPN, which allows the use of short numbers between subscribers of the private network, and the Personal Number, where the intelligent network re-routes calls made to the personal number in a manner controlled by the subscriber. IN-services are utilized by various networks, such as mobile communications networks and fixed networks connected to IN.

The physical architecture of the intelligent network is illustrated in FIG. 1, where the physical entities are shown as rectangles or cylinders and the functional entities located in them are shown as ovals. This architecture is described briefly below, since references will be made to an intelligent network environment in the description of the invention to follow. The intelligent network is described in ITU-T recommendations Q.121X and in Bellcore's AIN recommendations, for example, where an interested reader can find more background information. ETS 300 374-1 CoreINAP terms will be used in the description of the invention and its background, but the invention can also be used in intelligent networks implemented in accordance with other intelligent network standards.

The Subscriber Equipment SE, which may be a telephone, a mobile station, a computer, or a fax, for example, is either connected directly to a Service Switching Point SSP or to a Network Access Point NAP. A service switching point SSP provides the user with access to the network and attends to all necessary dialing functions. The SSP is also able to detect the need for an intelligent network service request. In functional terms, the SSP includes call management, routing, and service dialing functions.

The Service Control Point SCP includes Service Logic Programs SLP, which are used to produce intelligent network services. In the following, “service program” will also be used as a shorter form for “service logic programs”.

The Service Data Point SDP is a database containing data about the subscriber and the intelligent network which the SCP service programs use for producing individualized services. The SCP may use SDP services directly by way of a signaling or data network.

The Intelligent Peripheral IP provides special functions, such as announcements and voice recognition.

The signaling network shown in FIG. 1 is a network according to Signalling System Number 7 (SS7), a known signaling system described in the Specifications of Signalling System No. 7 of the CCITT (nowadays ITU-T), Melbourne 1988.

The Call Control Agent Function (CCAF) ensures that the end user (subscriber) has access to the network. Access to IN-services is implemented through additions made to existing digital exchanges. This is done by using the Basic Call State Model BCSM, which describes the various stages of call handling and includes points called Detection Points DP, where the call handling can be interrupted in order to start intelligent network services. At these detection points, the service logic entities of the intelligent network are permitted to interact with the basic call and connection control capabilities. Therefore, Detection Points DP describe those points in call and connection processing where the transfer of control can occur.

In the exchange, the call set-up is divided into two parts: the call set-up in the originating half and the call set-up in the terminating half. As a rough description, call handling in the originating half is related to the services of the calling subscriber, while call handling in the terminating half is related to the services of the called subscriber. The corresponding state models are the Originating Basic Call State Model (O-BCSM) and the Terminating Basic Call State Model (T-BCSM). The BCSM is a high-level state automaton description of those Call Control Functions (CCF) needed for setting up and maintaining a connection between the users. Functionality is added to this state model with the aid of the Service Switching Function (SSF) (cf. partial overlapping of CCFs and SSFs in FIG. 1) to make it possible to decide when intelligent network services (IN-services) should be requested. When IN-services have been requested, the Service Control Function (SCF), including the service logic of the intelligent network, attends to the service-related processing (of call handling). Thus, the Service Switching Function SSF connects the Call Control Function CCF to the Service Control Function SCF and allows the Service Control Function SCF to control the Call Control Function CCF.

The intelligent network service is implemented in such a way that in connection with the encounter of service-related detection points proceedings in the call handling model BCSM are suspended, and the Service Switching Point SSP asks the Service Control Point SCP for instructions with the aid of messages relayed over the SSPISCP interface. In intelligent network terminology these messages are called operations. The SCF may request, for example, that the SSF/CCF perform certain call or connection functions, such as charging or routing actions. The SCF may also send requests to the Service Data Function (SDF), which provides access to service-related data and network data of the intelligent network. Thus the SCF may request, for example, that the SDF fetches data concerning a certain service or that it updates this data.

The Intelligent Network functions involved in interaction with the subscriber are supplemented by a Specialised Resources Function SRF providing an interface for those network mechanisms. Examples of such functions are messages to the subscriber and the collection of the subscriber's dialing.

The following is a brief description of the role of the functional entities shown in Figure i in terms of IN-services. The CCAF receives the service request of the calling party, typically made by the calling party by lifting the receiver and/or dialing a certain number series. The CCAF relays the service request further to the CCFISSF for processing. The CCF has no service data, but it is programmed to identify those detection points where a SCP visit might be made. The CCF interrupts the call set-up for a moment and gives the service switching function SSF data about the detection point encountered (about the stage of the call set-up). It is the duty of the SSF through use of predetermined criteria to interpret whether a service request to the intelligent network is necessary. If this is the case, the SSF sends to the SCF a standardized IN-service request, including data related to the call. The Global Title address of the SCP providing the service is included in the trigger data of the subscriber. The SCF receives the IN-service request and decodes it. Then it works together with the SSF/CCF, SRF, and SDF in order to produce the requested service for the end user.

In certain cases, the SCP is not able to provide the requested service. After sending the IN-service request, the SSP waits for some predetermined time for a response from the SCP. If no response is received during that time, the SSP deems the service unavailable and aborts it. Sometimes this abort procedure aborts the call as well. The SCP can also respond to the service request by rejecting it when the requested service can not be provided.

The Call Gap procedure is used to request the SSF to reduce the rate at which specific service requests are sent to the SCF. The rate is defined as the number of requests during a certain time period, for example. When the limit set by the SCF is reached, the SSF refrains from sending any more service requests to the SCF in question, until it is permitted to do so again according to the limit.

The problem with prior art service initiation is that the requested service can not be initiated when the responsible SCP is not able to provide the service, due to equipment failure or congestion, for example. In such cases, the service initiation ends with failure.

### BRIEF SUMMARY OF THE INVENTION

It is the purpose of this invention to implement effective initiation of services in an intelligent network.

This purpose is achieved through methods and telecommunications networks according to the invention which are characterized by the independent claims. Different embodiments of the invention are presented in the dependent claims.

The invention is based on the idea that at least two control point addresses are set to which a service request can be sent, and that the service request is sent to the address selected on the basis of the congestion information and/or the service request is sent to the set addresses one at a time, until service is initiated at one address.

One advantage of the invention is that the availability of services is improved and ensured, especially during congestion. Additionally, errors in providing service caused by congestion situations are minimized, as the service load is controlled by the SCP via the SSP. On the other hand, failure tolerance is increased when the initiation of the service is ensured with the retransmission mechanism according to the invention.

Another advantage of the invention is that the execution of services can be distributed between SCPs to divide the load more evenly between different SCPs.

### LIST OF FIGURES

The invention is now described more closely in connection with preferable embodiments, with reference to the examples shown in FIGS. 2-5 in the appended drawings, wherein:

FIG. 1 shows parts of an intelligent network structure which are essential to the invention,

FIG. 2 shows the first embodiment of the invention as a flow chart;

FIG. 3 shows the first embodiment of the invention in an example network;

FIG. 4 shows the second embodiment of the invention as a flow chart; and

FIG. 5 shows the second embodiment of the invention in an example network.

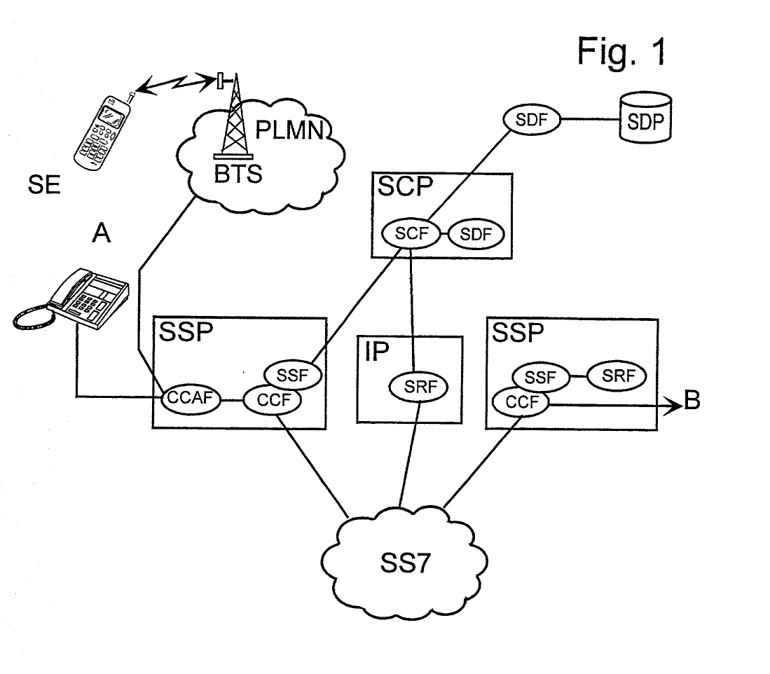

### BRIEF DESCRIPTION OF THE INVENTION

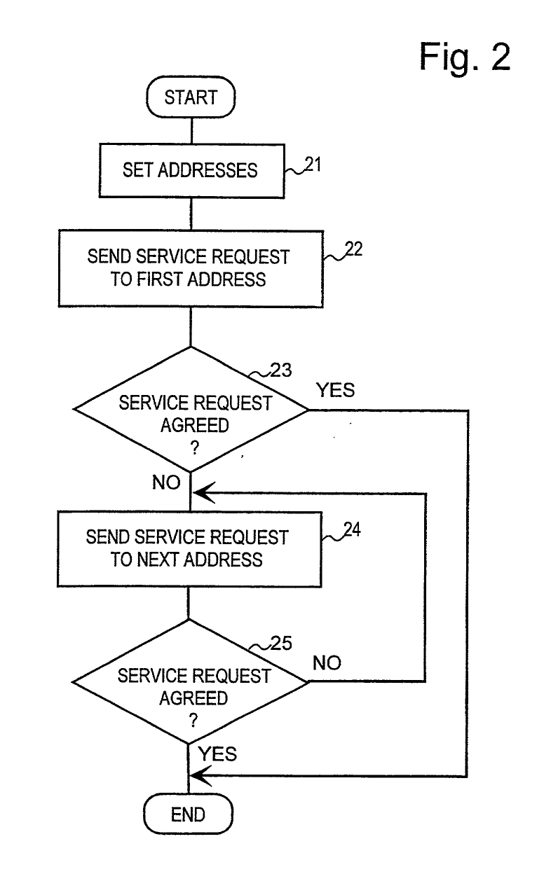

In the following, the first embodiment of the invention is described more closely with reference to the flow chart in FIG. 2. According to the invention at stage 21, at least two addresses are set to which a service request relating to a certain service can be sent. These addresses are preferably Global Title (GT) or similar addresses unambiguously identifying the service control points providing the service in the network. Stage 21 need necessarily not be performed in every call but rather the addresses are set and modified as required. In the intelligent network, the addresses according to the invention are preferably stored in the trigger data of IN-services. Alternatively, the list of addresses may be stored in the service switching point. A priority indication can be added to the set addresses in the trigger data. An advantage with the priority indication is that it facilitates the control of the loading in the network. At stage 22 in FIG. 2, a service request is sent by the SSP to the first address identifying one SCP. The first address is selected either randomly or based on the optional priority indication from among the addresses set earlier. The response to the service request is monitored at stage 23. When the SCP agrees to provide the requested service, the process is continued according to prior art. If there is no response from the first address during a predetermined waiting period or the service request is refused with an abort operation, for example, the next address is selected either randomly or based on the optional priority indication from the addresses set earlier, and the service request is sent to that next address identifying another SCP (stage 24). At stage 25, it is monitored whether the requested service has been initiated at the latest address. If again there is no response or the service request is refused, a new address is selected, either randomly or based on the optional priority indication from among the addresses set earlier, and the service request is sent to this new address (stage 24). Stages 24 and 25 are repeated until the service is initiated at one of the addresses. Optionally, the re-sending of the service request can be limited to a maximum number of service requests sent for one initiation, a time limit, and/or other applicable restrictions.

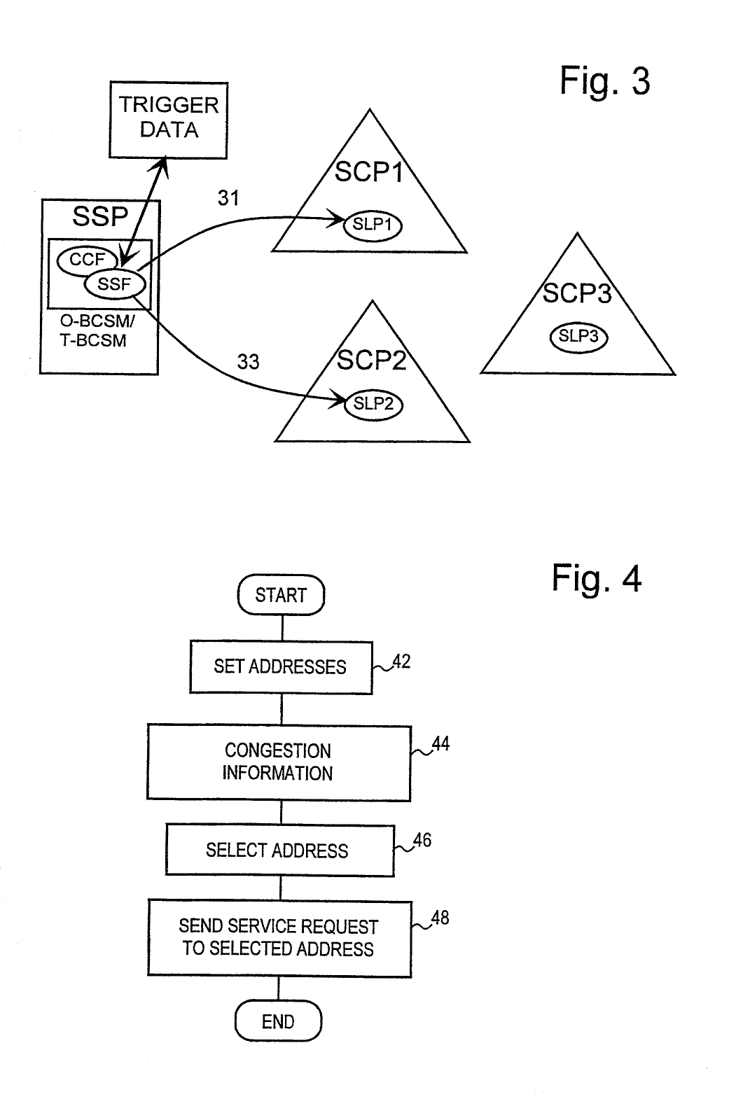

FIG. 3 shows an intelligent network structure with service initiation according to the first embodiment of the invention. In FIG. 3, at least two addresses to which a service request can be sent are set in the trigger data. In this example, they are the addresses of SCP1, SCP2, and SCP3. Each of these service control points includes a service program, i.e. SLPI, SLP2, and SLP3, which can provide the same service. The SSP retrieves trigger data from a database and uses this data in the call handling model O-BCSM or TBCSM. In the first embodiment of the invention, a service request is first send to SCP1 in operation 31. In the example, SCP1 is not able to provide the service. According to the invention, the SSP selects the next address from among the addresses set in the trigger data and sends the service request to this address, i.e. to SPC2, in operation 33. In this example, SCP2 initiates the requested service, and call handling is continued according to prior art. The address to which a service request is sent each time is either selected randomly or on the basis of the optional priority indication described above.

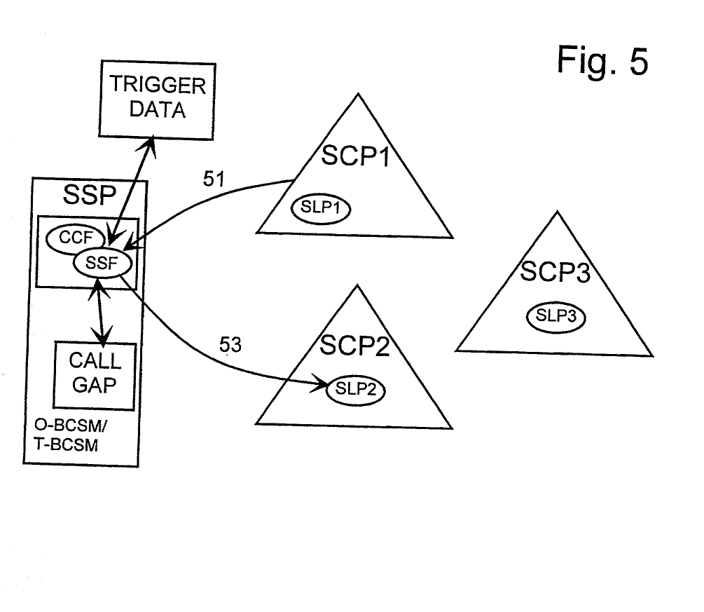

Next, the first implementation of the second embodiment of the invention is described more closely referring to FIGS. 4 and 5. FIG. 4 shows the first implementation of the second embodiment as a flow chart. At stage 42, at least two addresses are set to which a service request relating to a certain service can be sent. Stage 42 corresponds to stage 21 described above in connection with the first embodiment. At stage 44, at least one SCP sends congestion information to the SSP according to prior art. The congestion information, such as call gap information, informs the SSP of the capacity limitations of the SCP and instructs the SSP to reduce the rate at which specific service requests are sent to the SCP in question. The call gap information is preferably stored in a database. According to the invention, an address to which a service request is to be sent is selected on the basis of this congestion information, such as call gap information (stage 46). In order to be able to utilize the invention, identification information of the SCP in question has to be attached to the congestion information. From amongst the addresses set, an address is selected for which the call gap limit has not yet been reached. In another embodiment of the invention, the loading is distributed by selecting the address with no call gap information or with the least restricting call gap information. For example, if SCPI has sent call gap information requesting reduction in the rate of service requests to 5 requests per second and SCP2 has sent call gap information with the restriction of 4 requests per second, SCP1 has less restricting call gap information and the address of SCP1 is selected for the service request, provided that the restricting limit has not yet been reached. If the same SCP has provided call gap information more than once, the call gap information relating to the service in question is used in the method according to the invention. At stage 48 in FIG. 4, a service request is sent to the selected address.

In the second implementation of the second embodiment, the congestion information is based on the number of service requests sent by the switching point SSP to a certain control point. Thus, the congestion information for one control point is determined by the number of the service requests sent by the SSP to this control point during a predetermined period, for example. At stage 44 in FIG. 4, the congestion information is acquired by the SSP. From amongst the addresses set, an address is selected based on this congestion information in such a way that the loading is distributed by selecting the address with the least congestion (stage 46). For example, if during time period of one second two service requests has been sent by the SSP to SCP1 and none to SCP2, SCP2 has less congestion and the address of SCP2 is selected for the service request. Otherwise, the second implementation corresponds to the first implementation described above.

In the second embodiment of the invention, an overloaded SCP is not burdened with the service request, but instead the service request is sent to an SCP still having capacity for providing the service. This selection improves the probability that the service request is agreed to by the SCP receiving the request.

FIG. 5 shows the first implementation of the second embodiment of the invention in an example of an intelligent network structure. As described above in connection with FIG. 3, at least two addresses to which a service request can be sent are set in the trigger data. In this example, the addresses set are the addresses of SCP1, SCP2, and SCP3. The SSP retrieves trigger data from a database and uses this data in the call handling model O-BCSM or T-BCSM. In FIG. 5, SCP1 sends call gap information to the SSP, which preferably stores it in the call gap database. When a certain service is needed during the call, the SSP selects the service control point to which a service request is sent from amongst the addresses set in the trigger data for this service. The selection is made by taking into consideration the call gap information provided earlier and possibly stored in the database. In the example in FIG. 5, SCP2 is selected for the service providing point. A service request is send to SCP2 in operation 53. SCP2 initiates the requested service, and call handling is continued according to prior art.

The first and second embodiments described above can also be combined. In the combined solution the first address to which a service request is sent is selected on the basis of the congestion information provided, such as call gap information, and the service request is re-sent to the next address selected on the basis of the congestion information provided, when the service request is not agreed to at the first address. Re-sending is continued until the service is initiated at one of the addresses unless re-sending is limited by a preset restriction before that.

The drawings and the explanations related to them are only intended to illustrate the inventive idea. The initiating of services in accordance with the invention may vary in detail within the scope defined by the claims. The invention can be implemented in any telecommunications network in which services are provided by separate service programs. These networks comprise both mobile and fixed telecommunication networks. The invention can also be implemented in packet-switched networks. Therefore, in this application the term “call” refers also to packet switched connections. Although the invention is described above mainly in terms of SCP addresses, it may also be used with addresses of other kinds of control elements carrying out a functionality corresponding to the SCP. The switching unit example presented above was an SSP in an IN-network, but a mobile services switching center or any other switching unit is possible as well. The service programs described above can be switch-based services, e.g. supplementary services of the GSM, IN-services, or services similar to IN-services which have some other interface than an IN-interface between the controlling program packet and the controlled switching unit. Partial implementation of the invention in the network is also possible. For example, implementation according to the invention can be limited to only certain service programs in the network.

1. Method of initiating services in a telecommunications network including at least one switching point (SSP) and at least two control points (SCP1, SCP2, SCP3) for controlling services, which control points each have a unique address, in which method a service request is sent by the switching point (SSP) to the control point (SCP) in order to initiate a service, characterized in that in the method
at least two control point addresses are set to which a service request can be sent and
a service request is sent to the control point addresses set one at a time, until the service is initiated at one of the addresses.

2. Method according to claim 1, characterized in that
the service request is sent to one address (SCP1) and
when this address does not initiate the service, the service request is sent to another address (SCP2), until the service is initiated at one of the addresses.

3. Method according to claim 2, characterized in that
at least one control point (SCP1) provides the switching point (SSP) with congestion information,
the service request is sent to one address selected on the basis of the congestion information, and
when this address does not initiate the service, the service request is sent to another address selected on the basis of the congestion information, until the service is initiated at one of the addresses.

4. Method according to claim 1, characterized in that
the telecommunications network is an intelligent network and
the addresses are set in the trigger data of IN-services.

5. Method according to claim 2, characterized in that
a priority indication is attached to the addresses set and
another address is selected on basis of the priority indication.

6. Method according to claim 2, 3, or 4, characterized in that the service request is sent to another address when the previous address does not respond.

7. Method according to claim 2, 3, or 4, characterized in that the service request is sent to another address when the previous address refuses to initiate the service.

8. Method according to any one of claims 1-5, characterized in that the re-sending of the service request is controlled by a limit.

9. Method of initiating services in a telecommunications network including at least one switching point (SSP) and at least two control points (SCP1, SCP2, SCP3) for controlling services, which control points each have a unique address, in which method a service request is sent by the switching point (SSP) to the control point (SCP) in order to initiate a service, and the switching point (SSP) has congestion information of at least one control point (SCP), characterized in that in the method
at least two control point addresses are set to which a service request can be sent and
a service request is sent to a control point address selected on the basis of the congestion information.

10. Method according to claim 9, characterized in that the congestion information is sent by at least one control point (SCPI), which congestion information restricts the rate at which service requests are sent to this control point (SCP1).

11. Method according to claim 9, characterized in that the congestion information is based on the number of service requests sent by the switching point (SSP) to the control point (SCP).

12. Method according to claim 10, characterized in that the address which still has free capacity according to the congestion information is selected.

13. Method according to claim 9, 10 or 11, characterized in that the address which has the least restricting congestion information is selected.

14. Method according to claim 9, characterized in that
the service request is sent to one address selected on the basis of the congestion information and
when this address does not initiate the service, the service request is sent to another address selected on the basis of the congestion information, until the service is initiated at one of the addresses.

15. Method according to claim 14, characterized in that
a maximum number for initiation attempts is set,
it is checked whether the service is initiated at the latest address,
it is checked whether the maximum number of initiation attempts is reached, and
the service request is sent to another address selected on the basis of the congestion information, until the result of one of the checks is “true”.

16. Method according to claim 14 or 15, characterized in that the service request is sent to another address when the previous address does not respond.

17. Method according to claim 14 or 15, characterized in that the service request is sent to another address when the previous address refuses to initiate the service.

18. Method according to claim 9, characterized in that
the telecommunications network is an intelligent network and
the addresses are set in the trigger data of IN-services.

19. A telecommunications network including at least one switching point (SSP), at least two control points (SCP1, SCP2, SCP3) for controlling services, which control points each have a unique address, and a database for storing information relating to services, in which network the switching point (SSP) sends a service request to the control point (SCP) in order to initiate a service,
characterized in that
in the database, at least two control point addresses are stored to which a service request can be sent and
the switching point (SSP) is adapted to send a service request to the set control point addresses one at a time, until the service is initiated at one of the addresses.

20. A switching point for a telecommunications network including at least one switching point (SSP), at least two control points (SCP1, SCP2, SCP3) for controlling services, which control points each have a unique address, and a database for storing information relating to services, in which network the switching point (SSP) sends a service request to the control point (SCP) in order to initiate a service,
characterized in that the switching point (SSP) is adapted
to receive a list of at least two control point addresses to which a service request can be sent and
to send a service request to the set control point addresses one at a time, until the service is initiated at one of the addresses.

21. A telecommunications network including at least one switching point (SSP), at least two control points (SCP1, SCP2, SCP3) for controlling services, which control points each have a unique address, and a database for storing information relating to services, in which network the switching point (SSP) sends a service request to the control point (SCP) in order to initiate a service and the switching point (SSP) has congestion information of at least one control point (SCP),
characterized in that
in the database, at least two control point addresses are stored to which a service request can be sent and
the switching point (SSP) is adapted to send a service request to a control point address selected on the basis of the congestion information.

22. A switching point for a telecommunications network including at least one switching point (SSP), at least two control points (SCP1, SCP2, SCP3) for controlling services, which control points each have a unique address, and a database for storing information relating to services, in which network the switching point (SSP) sends a service request to the control point (SCP) in order to initiate a service and the switching point (SSP) has congestion information of at least one control point (SCP),
characterized in that the switching point (SSP) is adapted
to receive a list of at least two control point addresses to which a service request can be sent and
to send a service request to a control point address selected on the basis of the congestion information.
